(19) United States
(12) Patent Application Publication
(10) Pub. No.: US 2005/0005026 A1
(43) Pub. Date: Jan. 6, 2005

(54) Method and apparatus for managing a remote data processing system

(75) Inventors: Deanna Lynn Quigg Brown, Pflugerville, TX (US); David ZhiWei Dai, Austin, TX (US); Jeffrey Paul Messing, Austin, TX (US); Vasu Vallabhaneni, Austin, TX (US); Patrick Tam Vo, Houston, TX (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 10/614,629

(22) Filed: Jul. 3, 2003

(51) Int. Cl. G06F 15/16

(52) U.S. Cl. 709/245; 709/203

(57) ABSTRACT

A method, apparatus, and computer instructions for providing host information. A request is received for host information for a remote computer from a requester wherein the request includes one of a host name or an Internet Protocol address. The host information is received from a requester. A media access control address and a subnet mask is identified using the request, and a response is returned to the requester, wherein the response includes the media access control address and the subnet mask.

### BACKGROUND OF THE INVENTION

1. Technical Field

The present invention relates generally to an improved data processing system and in particular, a method and apparatus for processing data. Still more particularly, the present invention provides a method, apparatus, and computer instructions for managing a remote host data processing system.

2. Description of Related Art

In network data processing systems, remote wake-up abilities are often provided for clients. This type of feature allows a client that is in a sleep mode to be woken up through the network. With this feature, a system administrator or other user may wake-up a sleeping client by sending a selected type of network packet. This packet is called a “wake-up packet”. For example, with a network adapter, such as an Ethernet controller, the adapter is modified to listen for a special wake-up packet on a local area network (LAN) address even when the computer in which the network adapter is located is asleep in a power conservation mode. Upon receiving this packet, the network adapter checks the packet content to ensure that the packet is destined for this particular client. If the packet is destined for the client, the adapter wakes up the sleeping client. This type of technology also is referred to as “magic packet technology”.

This type of feature may be used on a large network data processing system in which the system administrator's data processing system is located on a different subnet from the clients that are being managed. A subnet is a division of a network into an interconnected, but independent, segment, or domain, in order to improve performance and security. In generating a wake-up packet, the remote data processing system's 48- bit media access control (MAC) address is encoded into the wake-up packet. A MAC address is a unique serial number that is used to identify a network card. Thereafter, the wake-up packet is broadcast to address 255.255.255.255 if the remote data processing system is on the same subset. Otherwise, this packet is sent to a subnet-directed broadcast address if the remote data processing system is located on another subnet.

To wake up a remote data processing system on a subnet, the administrator needs to have the remote data processing system's MAC address and subnet mask in addition to having the name of the remote data processing system or the IP address for the remote data processing system. The technique is used by the IP protocol to filter messages into a particular network segment (subnet). The subnet mask is a binary pattern that is stored in the client data processing system, server or router and is matched up with the incoming Internet Protocol (IP) address to determine whether to accept or reject the packet. It is inconvenient for an administrator to obtain a MAC address and subnet mask for all remote data processing systems managed by an administrator, especially when large numbers of clients are managed.

Therefore, it would be advantageous to have an improved method, apparatus, and computer instructions for identifying host information such as a MAC address and a subnet mask, for a remote data processing system.

### SUMMARY OF THE INVENTION

The present invention provides a method, apparatus, and computer instructions for providing host information. A request is received for host information for a remote computer from a requester wherein the request includes one of a host name or an Internet Protocol address. The host information is received from a requester. A media access control address and a subnet mask is identified using the request, and a response is returned to the requester, wherein the response includes the media access control address and the subnet mask.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of data processing systems in which the present invention may be implemented;

FIG. 2 is a block diagram of a data processing system that may be implemented as a server in accordance with a preferred embodiment of the present invention;

FIG. 3 is a block diagram illustrating a data processing system in which the present invention may be implemented;

FIG. 4 is a diagram illustrating components used in obtaining and providing host information for managing remote hosts in accordance with a preferred embodiment of the present invention;

FIG. 5 is a diagram illustrating a text record in accordance with a preferred embodiment of the present invention;

FIG. 6 is a flowchart of a process for obtaining host information from a DHCP client in accordance with a preferred embodiment of the present invention;

FIG. 7 is a flowchart of a process for a client to obtain an IP address from a DHCP server in accordance with a preferred embodiment of the present invention;

FIG. 8 is a flowchart of a process for updating host information in a name-to-address mapping file in accordance with a preferred embodiment of the present invention;

FIG. 9 is a flowchart of a process for allowing a DNS server to be dynamically updated with host information in accordance with a preferred embodiment of the present invention; and

FIG. 10 is a flowchart of a process for waking up a remote host in accordance with a preferred embodiment of the present invention.

### DETAILED DESCRIPTION OF THE PREFERRED EMBODIMENT

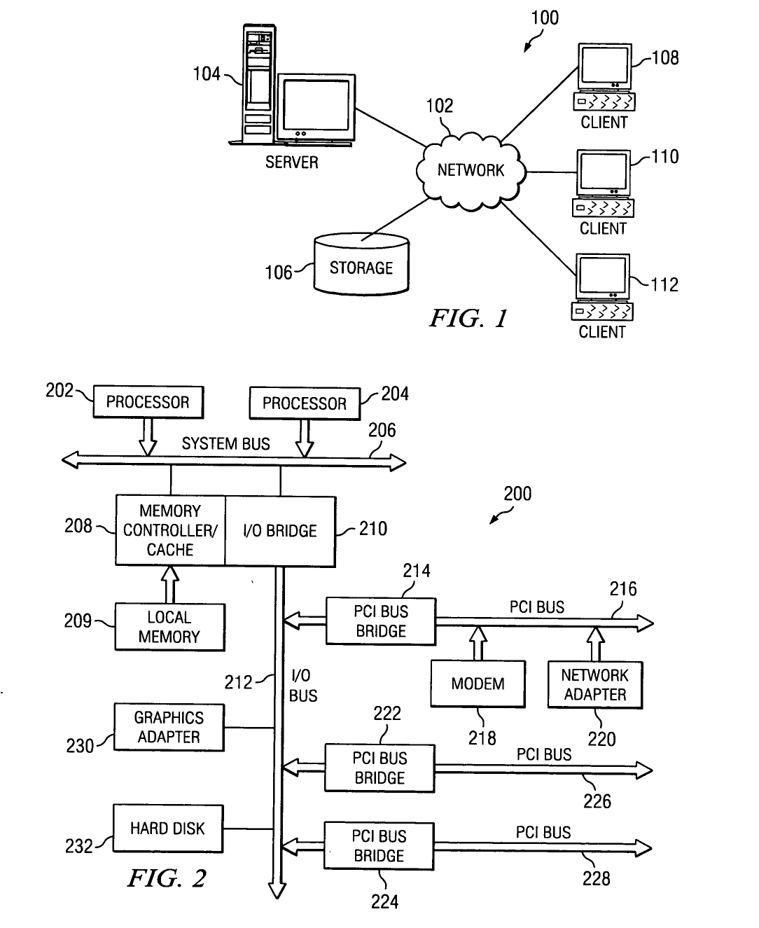

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown. In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCId) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in boards.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer pSeries system, a product of International Business Machines Corporation in Armonk, N.Y., running the Advanced Interactive Executive (AIX) operating system or LINUX operating system.

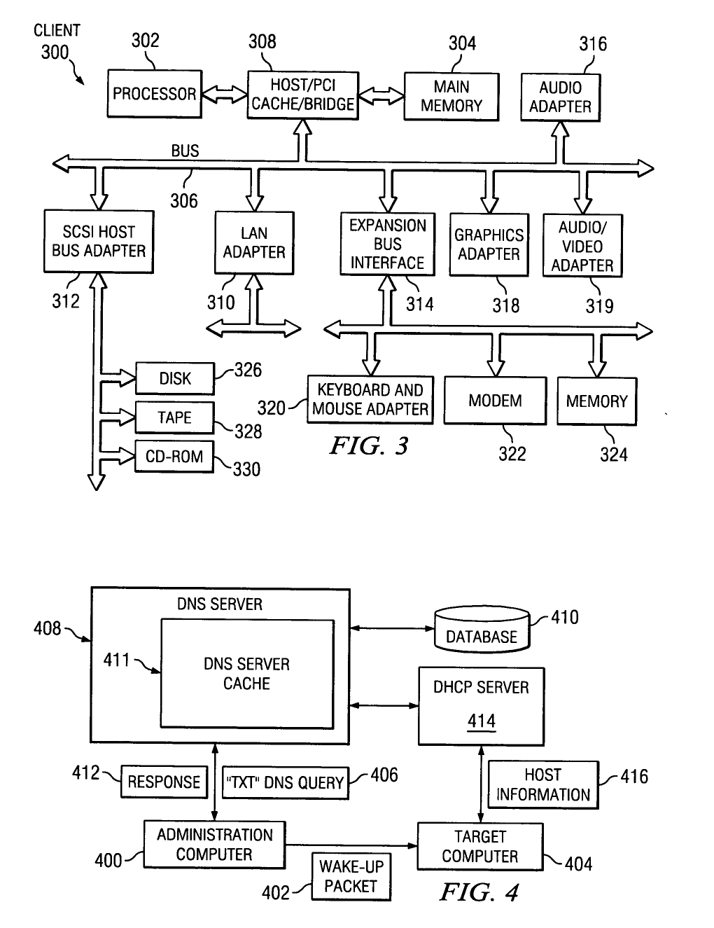

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash read-only memory (ROM), equivalent nonvolatile memory, or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interfaces. As a further example, data processing system 300 may be a personal digital assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

The present invention provides a method, apparatus, and computer instructions for identifying host information for a remote data processing system. In particular, the mechanism of the present invention identifies a MAC address and subnet mask for a remote data processing system that is to be woken up.

According a preferred embodiment of the present invention, if the remote data processing system, also referred to as a remote host, uses dynamic host configuration protocol (DHCP) to obtain an IP address, the DHCP server obtains the MAC address and subnet mask of the remote host as part of the process of assigning an IP address to this client. The mechanism of the present invention sends this information, along with the IP address, to a domain name system (DNS) server. If the remote host has a static IP address, this information is sent to the DNS server at the time the static address is provisioned for the remote host. As a result, when a remote host is to be woken up, an administrator, at a managing data processing system or host, sends a DNS query to a DNS server to obtain the MAC address and subnet mask. In this manner, an administrator or managing host is not required to know all of the host information for managed remote hosts. Such a feature is especially useful with respect to data processing systems in which IP addresses may change based on using DHCP.

Turning next to FIG. 4, a diagram illustrating components used in obtaining and providing host information for managing remote hosts is depicted in accordance with a preferred embodiment of the present invention. As illustrated, administration computer 400 is a managing host that generates wake-up packet 402 to wake-up target computer 404. Target computer 404 is a remote host in this example. In generating wake-up packet 402, administration computer 400 needs an IP address or name for target computer 404. With the IP address, the host name for target computer 404 may be obtained from DSN server 408. If the host name is known, the IP address may be obtained from DNS server 408.

Administration computer 400 also needs a MAC address and a subnet mask for target computer 404. The MAC address and subnet mask are the host information that is needed to generate wake-up packet 402. In these examples, this information may be obtained from DNS sever 408. DNS server 408 contains a mapping of names-to-addresses and a mapping of addresses-to-names in database 410. The mapping information in this database is loaded into DNS server cache 411.

To obtain the host information, administration computer 400 sends “TXT” DNS query 406 to DNS server 408. This query includes the host name for target computer 404. In these examples, this host information is located in the name-to-address mapping file. In response to receiving “TXT” DNS query 406, DNS server 408 queries DNS server cache 411 for host information, such as the MAC address and subnet mask. In this example, “TXT” DNS query 406 is for a text record for target computer 404.

The host name is used to identify this record in DNS server cache 411 to obtain the MAC address and the subnet mask for use in generating a wake-up packet. When the text record is found, this record is returned to administration computer 400 as response 412. With this information, administration computer 400 places the appropriate host information into wake-up packet 402.

The text records containing host information in database 410 may be provisioned on DNS server 408 through different mechanisms. One mechanism involves having DHCP server 414 obtain the host information from target computer 404 when assigning IP addresses. This mechanism is used with dynamic IP addresses. In the case of static IP addresses, the host information may be provisioned directly by a user or administrator.

In this example, with dynamic IP address, target computer 404 uses DHCP to obtain an IP address from DHCP server 414. As part of this process, DHCP server 414 retrieves host information 416 from target computer 404. As illustrated, host information 416 is the MAC address and subnet mask for target computer 404. DHCP server 414 sends host information 416 as an update to DNS server 408. This information is placed into DNS server cache 411. Thus, queries from users, such as one at administration computer 400, may be processed to provide host information needed for management activities, such as waking up a remote host with a wake-up packet.

DNS server cache 411 contains the most up-to-date host information in these examples. Periodically, DNS server 408 updates database 410 with information from DNS server cache 411. In particular, a name-to-address mapping file and an address-to-name mapping file in database 410 is updated from DNS server cache 411.

In the case in which target computer 404 has a static IP address, the MAC address and subnet mask is provided to DNS sever 408 by a user or system administrator. This provisioning of host information is typically performed when the static IP address is provisioned. This information only needs to be provided to DNS server 408 once. As a result, future queries for host information causes DNS server 408 to provide that information to the requesters. In this manner, an administrator does not need to know all of the host information for a remote host. Knowledge of the IP address or name of the remote host is sufficient.

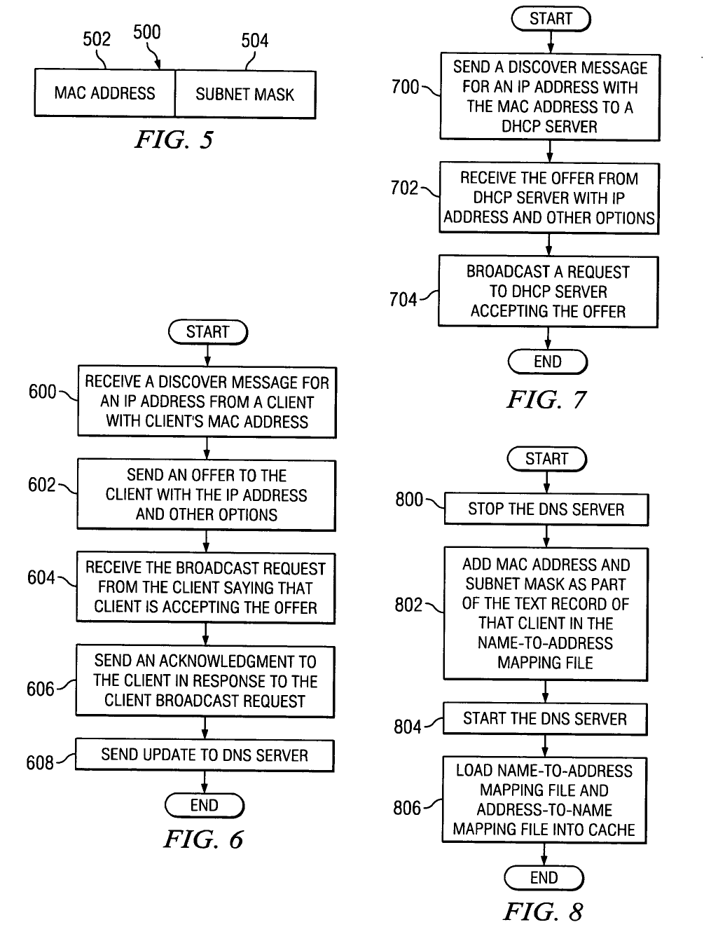

Turning next to FIG. 5, a diagram illustrating a text record is depicted in accordance with a preferred embodiment of the present invention. Text record 500 is an example of a record that may be located in a DNS server database, such as database 410 in FIG. 4. Text record 500 includes MAC address 502 and subnet mask 504. In these examples, the data populating these fields are strings. MAC address field 502 and subnet mask 504 also include a key word as a prefix to the string. For example, the string “MAC” is a prefix to the following for MAC address field 502: “MAC:00:04:ac:17:06:87”. Subnet mask 504 contains “Subnetmask” as a prefix for: “Subnetmask: 0xffffff00”. This information is included for text records for name-to-address files in a DNS database.

Turning next to FIG. 6, a flowchart for obtaining host information from a DHCP client depicted in accordance with a preferred embodiment of the present invention. The process illustrated in FIG. 6 may be implemented in a DHCP server, such as DHCP server 414 in FIG. 4.

The process begins by receiving a discover message for an IP address from a client with the client's MAC address (step 600). An offer is sent to the client with the IP address and other options (step 602). Other options may include, for example, gateways, DNS servers and subnet masks. A broadcast request is then received from the client indicating that the client accepts the offer (step 604). Thereafter, an acknowledgement is sent to the client in response to the client receiving the broadcast request. Afterward, an update is sent to DNS server (step 608) with the process terminating thereafter. This update includes the MAC address, the IP address, and the subnet mask.

Turning next to FIG. 7, a flowchart of a process for a client to obtain an IP address from a DHCP server is depicted in accordance with a preferred embodiment of the present invention. The process illustrated in FIG. 7 may be implemented in a data processing system, such as target computer 404 in FIG. 4.

The process begins by sending a discover message for an IP address to a DHCP server (step 700). This discover message includes the MAC address of the host. An offer is received from a DHCP server with the IP address and other options (step 702). In response to receiving this offer, a request is broadcast to the DHCP server accepting the offer (step 704) with the process terminating thereafter.

Turning now to FIG. 8, a flowchart of a process for updating host information in a name-to-address mapping file is depicted in accordance with a preferred embodiment of the present invention. This process allows for updates to be made when a static IP address is assigned.

The process begins by stopping the DNS server (step 800). A MAC address and subnet mask is added as part of the text record of that client in the name-to-address mapping file (step 802). Then, the DNS server is restarted (step 804). The DNS server then loads the address to name mapping file and the name to address mapping file in to the cache (step 806) with the process terminating thereafter.

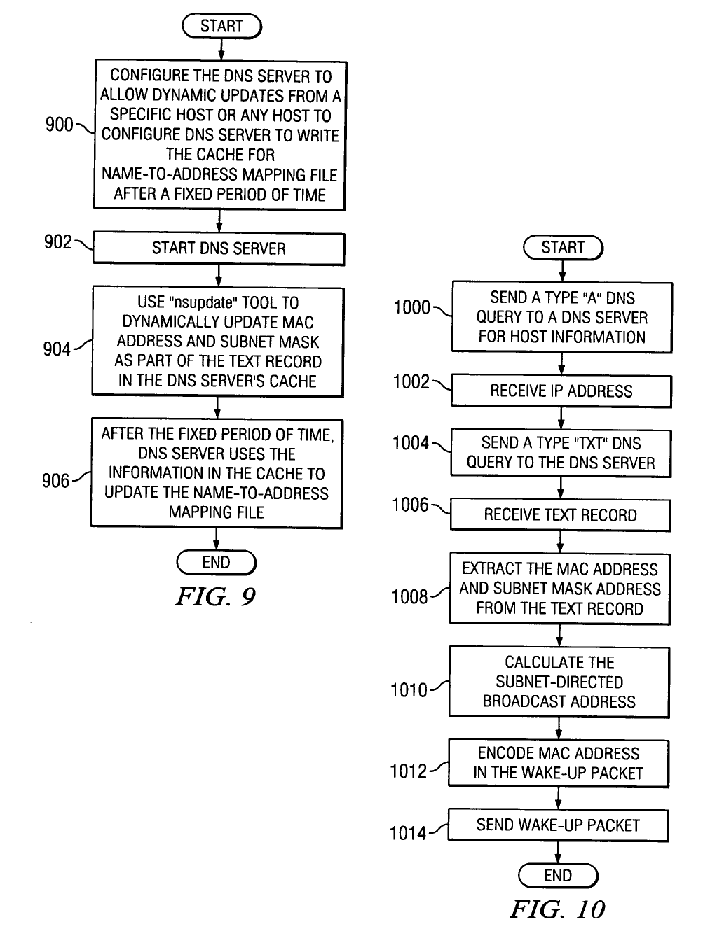

Turning now to FIG. 9, a flowchart of a process for allowing a DNS server to be dynamically updated with host information is depicted in accordance with a preferred embodiment of the present invention. The process is illustrated in FIG. 9 may be used with a DNS server, such as DNS server 408 in FIG. 4.

The process begins by configuring the DNS server to allow dynamic updates from a specific host or from any host to configure the DNS server to write information to a cache in which the information is used to update a name-to-address mapping file after a fixed period of time (step 900).

Next, the DNS server is started (step 902). An “nsupdate” tool is used to dynamically update the MAC address and the subnet address as part of the text record in the DNS server's cache (step 904). The “nsupdate” tool may be obtained from the Internet Software Consortium. This tool is one that may be used by a user to dynamically update DNS mapping information in the DNS server cache. After the fixed period of time passes, the mapping information in the cache is used to update the name-to-address mapping file (step 906) with the process terminating thereafter.

Turning now to FIG. 10, a flowchart of a process for waking up a remote host is depicted in accordance with a preferred embodiment of the present invention. The process illustrated in FIG. 10 may be implemented in a computer, such as administration computer 400 in FIG. 4. This process may be initiated with a user providing only a remote host name.

The process begins by sending a type “A” DNS query to a DNS server for host information (step 1000). This query includes the host name, but requires no other host information. This type of query results in an IP address being returned for the host name. After the query has been sent, an IP address is received (step 1002). Next, a type “TXT” DNS query is sent to the DNS server (step 1004). This query also requires only a host name and is used to obtain a text record. Thereafter, a text record is received from the DNS server.

The MAC address and subnet mask is extracted from the text record returned from the DNS server (step 1008). This information is used to calculate a subnet broadcast address (step 1010). The MAC address received in the text record from the DNS server is encoded into a wake-up packet (step 1012). The wake-up packet is then sent to the subnet-directed broadcast address (step 1014) with the process terminating thereafter.

A similar process may be used to send a wake-up packet to a remote host in which only an IP address is used. In this case, the first query sent is a type “PTR” DNS query containing the IP address, which results in a host name being returned for the IP address. Steps similar to steps 1004-1014 are used as described above. In step 1004, the type “TXT” DNS query is sent using the host name. In these examples, the host information is present in the name-to-address mapping file.

Thus, the present invention provides a method, apparatus, and computer instructions for obtaining host information for a remote host or data processing system. The mechanism of the present invention avoids a user or process having to store or identify all of the host information for a remote host. The host information needed may be obtained from a server, such as a DNS server, using a query containing a host name for the remote host. Host information, such as a MAC address and a subnet mask is supplied in response to the query. This information may then be used to direct packets, such as wake-up packets, to a remote host to wake up the remote host. Management of the remote data processing system is made more convenient for a user or administrator when the user or administrator only needs to provide a host name or IP address to generate a wake-up packet.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A method in a data processing system for providing host information, the method comprising:
receiving a request for host information for a remote computer from a requestor wherein the request includes one of a host name or an Internet Protocol address and is received from the requester;
identifying a media access control address and a subnet mask using the request; and
returning a response to the requester, wherein the response includes the media access control address and the subnet mask.

2. The method of claim 1, wherein the requester generates a wake-up packet using the host information and sends the wake-up packet to the remote computer.

3. The method of claim 1, wherein the media access control address and the subnet mask are received from a dynamic host configuration protocol server and are stored in a data processing system for the data processing system.

4. The method of claim 1, wherein the dynamic host configuration protocol server obtains the media access control address and the subnet mask from when a remote computer requests an address from the dynamic host configuration protocol server.

5. The method of claim 1, wherein the media access control address and the subnet are received from a user submitting the media access control address and the subnet mask and are stored in a data processing system for the data processing system.

6. The method of claim 1, wherein the data processing system is a domain name server.

7. The method of claim 1, wherein the media access control address and the subnet mask are stored record for a name-to-address file and an address-to-name file.

8. A data processing system for providing host information, the data processing system comprising:
receiving means for receiving a request for host information for a remote computer from a requestor wherein the request includes one of a host name or an Internet Protocol address and is received from the requester;
identifying means for identifying a media access control address and a subnet mask using the request; and
returning means for returning a response to the requester, wherein the response includes the media access control address and the subnet mask.

9. The data processing system of claim 8, wherein the requestor generates a wake-up packet using the host information and sends the wake-up packet to the remote computer.

10. The data processing system of claim 8, wherein the media access control address and the subnet mask are received from a dynamic host configuration protocol server and are stored in a data processing system for the data processing system.

11. The data processing system of claim 8, wherein the dynamic host configuration protocol server obtains the media access control address and the subnet mask from when a remote computer requests an address from the dynamic host configuration protocol server.

12. The data processing system of claim 8, wherein the media access control address and the subnet are received from a user submitting the media access control address and the subnet mask and are stored in a data processing system for the data processing system.

13. The data processing system of claim 8, wherein the data processing system is a domain name server.

14. The data processing system of claim 8, wherein the media access control address and the subnet mask are stored record for a name-to-address file and an address-to-name file.

15. A computer program product in a computer readable medium for providing host information, the computer program product comprising:
first instructions for receiving a request for host information for a remote computer from a requestor wherein the request includes one of a host name or an Internet Protocol address and is received from the requestor;
second instructions for identifying a media access control address and a subnet mask using the request; and
third instructions for returning a response to the requester, wherein the response includes the media access control address and the subnet mask.

16. The computer program product of claim 15, wherein the requester generates a wake-up packet using the host information and sends the wake-up packet to the remote computer.

17. The computer program product of claim 15, wherein the media access control address and the subnet mask are received from a dynamic host configuration protocol server and are stored in a data processing system for the data processing system.

18. The computer program product of claim 15, wherein the dynamic host configuration protocol server obtains the media access control address and the subnet mask from when a remote computer requests an address from the dynamic host configuration protocol server.

19. The computer program product of claim 15, wherein the media access control address and the subnet are received from a user submitting the media access control address and the subnet mask and are stored in a data processing system for the data processing system.

20. The computer program product of claim 15, wherein the data processing system is a domain name server.
